(19) United States
(12) Patent Application Publication
(10) Pub. No.: US 2022/0369120 A1
(43) Pub. Date: Nov. 17, 2022

(54) RADIO COMMUNICATION APPARATUS, AND RADIO COMMUNICATION METHOD

(71) Applicant: NIPPON TELEGRAPH AND TELEPHONE CORPORATION, Tokyo (JP)

(72) Inventors: Riku OMIYA, Musashino-shi, Tokyo (JP); Tomoki MURAKAMI, Musashino-shi, Tokyo (JP); Koichi ISHIHARA, Musashino-shi, Tokyo (JP); Takafumi HAYASHI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/625,816

(22) PCT Filed: Aug. 23, 2019
(86) PCT No.: PCT/JP2019/033135

§ 371 Date: Jun. 27, 2022

(51) Int. Cl. H04W 16/26; H04B 7/155

(52) U.S. Cl. CPC H04W 16/26; H04B 7/15507

(57) ABSTRACT

A wireless communication system including a transmitting station and one or more receiving stations, the one or more receiving stations including a receiving station serving as a destination, the receiving station serving as the destination receiving a transmitted signal from the transmitting station, the wireless communication system including a plurality of relay stations located between the transmitting station and the one or more receiving stations, wherein the transmitting station includes a relay station selection unit configured to select at least one relay station that relays the transmitted signal from among the plurality of relay stations, add information for turning on the at least one selected relay station to the transmitted signal, and transmit the transmitted signal, the at least one selected relay station is configured to be turned on in accordance with the information of the transmitted signal to perform a non-regenerative relay of the transmitted signal, and the receiving station serving as the destination is configured to receive the transmitted signal relayed via the at least one relay station that is turned on.

### TECHNICAL FIELD

The present invention relates to a wireless communication system and a wireless communication method by which a transmitting station transmits to a receiving station serving as a destination via one or more relay stations.

### BACKGROUND ART

In recent years, due to rapid popularization of wireless terminals, the amount of traffic on wireless networks has increased. To accommodate a large amount of wireless traffic, multi-input-multi-output (MIMO) techniques have been practically used in which transmitting stations and receiving stations use multiple antennas to improve communication capacity and communication quality. Examples of the MIMO techniques include (1) techniques for simultaneously transmitting multiple signals by spatial division multiplexing (SDM) to improve communication capacity, and (2) techniques for improving communication quality by diversity effects and beamforming using different propagation characteristics in multiple paths (Non Patent Literature (NPL) 1).

### CITATION LIST

### Non Patent Literature

NPL 1: G. J. Foschini, “Layered space time architecture for wireless communication in a fading environment when using multiple antennas,” Bell Labs Syst. Tech. J., vol. 1, pp. 41-59, Autumn 1996.

### SUMMARY OF THE INVENTION

### Technical Problem

In MIMO techniques, as described at above (2), by performing optimal beam (directivity) control corresponding to each MIMO channel, improvement in communication quality of the receiving station serving as the destination is expected.

On the other hand, in a case where there are other systems that use identical frequencies to those of the transmitting station and the receiving station, and there is an interfered station that is subject to interference by a transmitted signal from the transmitting station, the MIMO techniques are also effective for control for avoiding the interference to the interfered station at the time of transmission from the transmitting station to the receiving station serving as the destination.

However, using the MIMO techniques requires to estimate states of MIMO channels in both the transmitting station and the receiving station, prior to transmission of a packet.

An object of the present invention is to provide a wireless communication system and a wireless communication method that are capable of improving communication quality between a transmitting station and a receiving station that have no MIMO function.

### Means for Solving the Problem

A first invention is a wireless communication system including a transmitting station and one or more receiving stations, the one or more receiving stations including a receiving station serving as a destination, the receiving station serving as the destination receiving a transmitted signal from the transmitting station, the wireless communication system including a plurality of relay stations located between the transmitting station and the one or more receiving stations, wherein the transmitting station includes a relay station selection unit configured to select at least one relay station that relays the transmitted signal from among the plurality of relay stations, add information for turning on the at least one selected relay station to the transmitted signal, and transmit the transmitted signal, the at least one selected relay station is configured to be turned on in accordance with the information of the transmitted signal to perform a non-regenerative relay of the transmitted signal, and the receiving station serving as the destination is configured to receive the transmitted signal relayed via the at least one relay station that is turned on.

In the wireless communication system of the first invention, the relay station selection unit of the transmitting station is configured to select a combination of at least one of the plurality of relay stations in which a signal strength at the receiving station serving as the destination is a maximum value or is equal to or larger than a predetermined value.

In the wireless communication system of the first invention, an interfered station that is subject to interference by the transmitted signal from the transmitting station exists, and the relay station selection unit of the transmitting station is configured to select, from among combinations of at least one of the plurality of relay stations in which a signal strength at the interfered station is smaller than a predetermined value, a combination of at least one of the plurality of relay stations in which a signal strength at the receiving station serving as the destination is a maximum value or is equal to or larger than a predetermined value.

A second invention is a wireless communication method in which a transmitting station and one or more receiving stations exist, and a receiving station of the one or more receiving stations that serves as a destination receives a transmitted signal from the transmitting station, wherein a plurality of relay stations are located between the transmitting station and the one or more receiving stations, and the wireless communication method includes performing, by the transmitting station, relay station selection processing of selecting at least one relay station that relays the transmitted signal from among the plurality of relay stations, adding information for turning on the at least one selected relay station to the transmitted signal, and transmitting the transmitted signal, turning on the at least one selected relay station in accordance with the information of the transmitted signal to perform a non-regenerative relay of the transmitted signal, and receiving, by the receiving station serving as the destination, the transmitted signal relayed via the at least one relay station that is turned on.

In the wireless communication method of the second invention, in the relay station selection processing of the transmitting station, the transmitting station selects a combination of at least one of the plurality of relay stations in which a signal strength at the receiving station serving as the destination is a maximum value or is equal to or larger than a predetermined value.

In the wireless communication method of the second invention, an interfered station that is subject to interference by the transmitted signal from the transmitting station exists, and in the relay station selection processing of the transmitting station, the transmitting station selects, from among combinations of at least one of the plurality of relay stations in which a signal strength at the interfered station is smaller than a predetermined value, a combination of at least one of the plurality of relay stations in which a signal strength at the receiving station serving as the destination is a maximum value or is equal to or larger than a predetermined value.

### Effects of the Invention

The present invention may achieve a good signal strength at the receiving station serving as the destination and minimize interference to the interfered station as a result of the relay station selection.

### BRIEF DESCRIPTION OF DRAWINGS

FIG. 1 is a diagram illustrating a configuration example of a wireless communication system according to the present invention.

FIG. 2 is a diagram illustrating a configuration example of a transmitting station 10 of the wireless communication system according to the present invention.

FIG. 3 is a diagram illustrating a configuration example of a relay station 30 of the wireless communication system according to the present invention.

### DESCRIPTION OF EMBODIMENTS

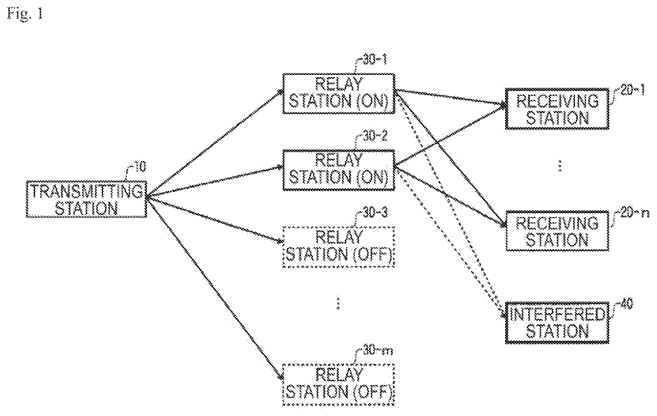

FIG. 1 illustrates a configuration example of a wireless communication system according to the present invention.

In FIG. 1, there are receiving stations 20-1 to 20-n (n is an integer equal to or larger than 1) that communicate with the transmitting station 10, and in unicast communication or multicast communication, the receiving station specified by a destination address in a transmitted signal receives the transmitted signal. Further, there are other systems that use identical frequencies to the transmitting station 10 and the receiving stations 20-1 to 20-n, and there is an interfered station 40 that is subject to interference by the transmitted signal from the transmitting station 10.

Here, a configuration is applied in which a plurality of relay stations 30-1 to 30-m are located between the transmitting station 10 and the receiving stations 20-1 to 20-n, and the transmitted signal is relayed via one or more relay stations that the transmitting station 10 selects according to the receiving station serving as the destination. Each relay station 30 has a function of turning relay processing on/off according to the selection by the transmitting station 10, and a non-regenerative relay function of relaying and transmitting the transmitted signal from the transmitting station 10 as it is when the relay processing is turned on.

One of the features of the present invention is that signal strengths at the receiving stations 20-1 to 20-n and the interfered station 40 are different according to a combination of one or more relay stations selected by the transmitting station 10, and thus, the combination of the one or more relay stations is selected according to the following applications.

(1) Select a combination of one or more relay stations so that the signal strength of the receiving station serving as the destination (for example, 20-1) is a maximum value or is equal to or larger than a predetermined value.

(2) Select a combination of one or more relay stations so that the signal strength of the receiving station serving as the destination (for example, 20-1) is a maximum value or is equal to or larger than a predetermined value, and the signal strength of the interfered station 40 is a minimum value or is smaller than a predetermined value. Note that the combination may be a combination of one or more relay stations in which the signal strength of the receiving station serving as the destination (for example, 20-1) is the maximum value or is equal to or larger than the predetermined value among combinations of one or more relay stations in which the signal strength of the interfered station 40 is smaller than the predetermined value.

In order to select the relay stations 30-1 to 30-m corresponding to the above applications, the transmitting station 10 needs to acquire the signal strengths at the receiving stations 20-1 to 20-n and the interfered station 40 for each combination of the one or more relay stations to be turned on. Here, according to the number of relay stations m, the number of the combinations of the one or more relay stations to be turned on is 2^{m}−1. The signal strengths at the receiving stations 20-1 to 20-n and the interfered station 40 are measured for each combination of the one or more relay stations to be turned on, and are fed back to the transmitting station 10 via the one or more relay stations to be turned on. Based on this information, the transmitting station 10 selects a combination of the one or more relay stations to be turned on according to the applications of (1) and (2) above, and generates and transmits the transmitted signal whose header is added with information for turning on the one or more relay stations. The relay stations 30-1 to 30-m check the header of the transmitted signal transmitted by the transmitting station 10, and only the one or more relay stations to be turned on relay and transmit the transmitted signal.

For example, for the application of (2) described above, FIG. 1 illustrates a state where, when the receiving station 20-1 serves as a destination, the relay stations 30-1 and 30-2 are selected as a combination of the one or more relay stations to be turned on in which the signal strength of the receiving station 20-1 is a maximum value or is equal to or larger than a predetermined value, and the signal strength of the interfered station 40 is smaller than a predetermined value. The transmitted signal from the transmitting station 10 is relayed by the relay stations 30-1 and 30-2, and is received by the receiving stations 20-1 to 20-n and the interfered station 40. Note that signal paths where the transmitted signal directly reaches the receiving stations 20-1 to 20-n and the interfered station 40 from the transmitting station 10 are omitted for the sake of brevity. Due to selection of the relay stations 30-1 and 30-2, good communication quality may be achieved at the receiving station 20-1 serving as the destination and interference to the interfered station 40 may be minimized.

Note that, in the above description, the signal strengths at the receiving stations 20-1 to 20-n and the interfered station 40 are measured for each combination of the one or more relay stations to be turned on and are fed back to the transmitting station 10. However, other methods are also applicable. For example, control signals may be bidirectionally transmitted between the transmitting station 10 and the receiving stations 20-1 to 20-n and between the transmitting station 10 and the interfered station 40 via the relay stations 30-1 to 30-m, and the transmitting station 10 may analyze channel information (phases and strengths) related to the control signals at the relay stations 30-1 to 30-m, thereby the distribution of the signal strengths at the receiving stations 20-1 to 20-n and the interfered station 40 for each combination of the one or more relay stations may be calculated. The latter method is applicable even in a case where the function of returning the signal strength from the interfered station 40 may not be expected.

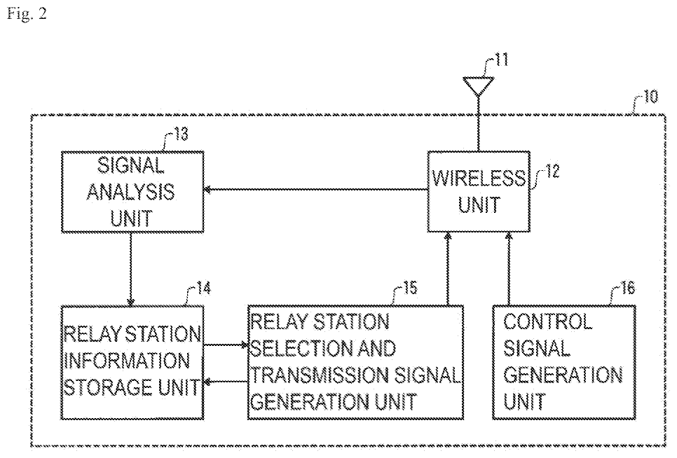

FIG. 2 illustrates a configuration example of the transmitting station 10 of the wireless communication system according to the present invention.

In FIG. 2, the transmitting station 10 includes an antenna 11, a wireless unit 12, a signal analysis unit 13, a relay station information storage unit 14, a relay station selection and transmission signal generation unit 15, and a control signal generation unit 16. Note that only blocks related to the present invention are described here, and blocks that are commonly used are omitted.

The control signal generation unit 16 generates control signals that cause the one or more relay stations to be turned on/off and that cause the signal strengths measured at the receiving stations 20-1 to 20-n and the interfered station 40 to be fed back to the transmitting station 10 for each combination of the one or more relay stations to be turned on, and transmits the generated control signals from the wireless unit 12 and the antenna 11. Alternatively, the control signals may be signals for collecting channel information between each of the relay stations 30-1 to 30-m and the receiving stations 20-1 to 20-n and between each of the relay stations 30-1 to 30-m and the interfered station 40.

The signal analysis unit 13 analyzes the information obtained by the control signal, and stores the information of the signal strengths at the receiving stations 20-1 to 20-n and the interfered station 40 in the relay station information storage unit 14 for each combination of the one or more relay stations to be turned on. The relay station selection and transmission signal generation unit 15 selects a combination of the one or more relay stations to be turned on based on the information in the relay station information storage unit 14 according to the receiving station serving as the destination, generates a transmission signal whose header is added with information for turning on the one or more relay stations, and transmits the generated transmission signal from the wireless unit 12 and the antenna 11.

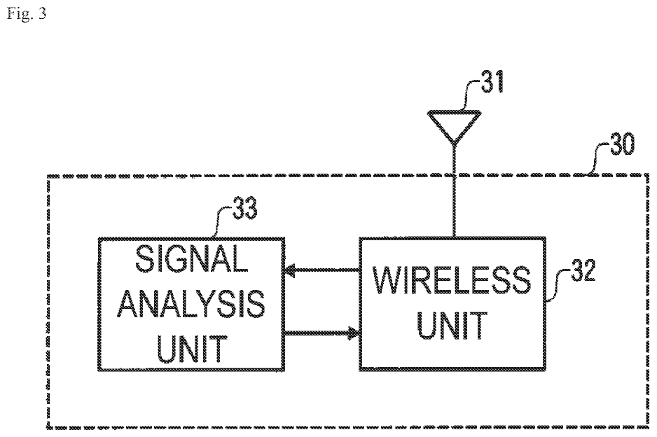

FIG. 3 illustrates a configuration example of each relay station 30 of the wireless communication system according to the present invention.

In FIG. 3, the relay station 30 includes an antenna 31, a wireless unit 32, and a signal analysis unit 33. Note that only blocks related to the present invention are described here, and blocks that are commonly used are omitted.

The signal received by the antenna 31 and the wireless unit 32 is input to the signal analysis unit 33, and the signal analysis unit 33 analyzes the header information to perform control of turning on/off the relay processing of the relay station 30. Furthermore, when the relay station 30 is turned on, the relay station 30 transmits the received signal as it is from the wireless unit 32 and the antenna 31.

### REFERENCE SIGNS LIST

10 Transmitting station
11 Antenna
12 Wireless unit
13 Signal analysis unit
14 Relay station information storage unit
15 Relay station selection and transmission signal generation unit
16 Control signal generation unit
20 Receiving station
30 Relay station
31 Antenna
32 Wireless unit
33 Signal analysis unit
40 Interfered station

1. A wireless communication system including a transmitting station and one or more receiving stations, the one or more receiving stations including a receiving station serving as a destination, the receiving station serving as the destination receiving a transmitted signal from the transmitting station, the wireless communication system comprising:
a plurality of relay stations located between the transmitting station and the one or more receiving stations, wherein
the transmitting station includes a relay station selection unit configured to select at least one relay station that relays the transmitted signal from among the plurality of relay stations, add information for turning on the at least one selected relay station to the transmitted signal, and transmit the transmitted signal,
the at least one selected relay station is configured to be turned on in accordance with the information of the transmitted signal to perform a non-regenerative relay of the transmitted signal, and
the receiving station serving as the destination is configured to receive the transmitted signal relayed via the at least one relay station that is turned on.

2. The wireless communication system according to claim 1, wherein
the relay station selection unit of the transmitting station is configured to select a combination of at least one of the plurality of relay stations in which a signal strength at the receiving station serving as the destination is a maximum value or is equal to or larger than a predetermined value.

3. The wireless communication system according to claim 1, further comprising
an interfered station that is subject to interference by the transmitted signal from the transmitting station, wherein
the relay station selection unit of the transmitting station is configured to select, from among combinations of at least one of the plurality of relay stations in which a signal strength at the interfered station is smaller than a predetermined value, a combination of at least one of the plurality of relay stations in which a signal strength at the receiving station serving as the destination is a maximum value or is equal to or larger than a predetermined value.

4. A wireless communication method in which a transmitting station and one or more receiving stations exist, and a receiving station of the one or more receiving stations that serves as a destination receives a transmitted signal from the transmitting station, wherein
a plurality of relay stations are located between the transmitting station and the one or more receiving stations, and
the wireless communication method comprises:
performing, by the transmitting station, relay station selection processing of selecting at least one relay station that relays the transmitted signal from among the plurality of relay stations, adding information for turning on the at least one selected relay station to the transmitted signal, and transmitting the transmitted signal;
turning on the at least one selected relay station in accordance with the information of the transmitted signal to perform a non-regenerative relay of the transmitted signal; and
receiving, by the receiving station serving as the destination, the transmitted signal relayed via the at least one relay station that is turned on.

5. The wireless communication method according to claim 4, wherein
in the relay station selection processing of the transmitting station, the transmitting station selects a combination of at least one of the plurality of relay stations in which a signal strength at the receiving station serving as the destination is a maximum value or is equal to or larger than a predetermined value.

6. The wireless communication method according to claim 4, wherein
an interfered station that is subject to interference by the transmitted signal from the transmitting station exists, and
in the relay station selection processing of the transmitting station, the transmitting station selects, from among combinations of at least one of the plurality of relay stations in which a signal strength at the interfered station is smaller than a predetermined value, a combination of at least one of the plurality of relay stations in which a signal strength at the receiving station serving as the destination is a maximum value or is equal to or larger than a predetermined value.
